(19) United States
(12) Patent Application Publication
(10) Pub. No.: US 2019/0213994 A1
(43) Pub. Date: Jul. 11, 2019

(54) VOICE OUTPUT DEVICE, METHOD, AND PROGRAM STORAGE MEDIUM

(71) Applicant: Toyota Jidosha Kabushiki Kaisha, Toyota-shi Aichi-ken (JP)

(72) Inventors: Hideki Kobayashi, Miyoshi-shi Aichi-ken (JP); Akihiro Muguruma, Nagoya-shi Aichi-ken (JP); Yukiya Sugiyama, Toyota-shi Aichi-ken (JP); Shota Higashihara, Chiryu-shi Aichi-ken (JP); Riho Matsuo, Nagoya-shi Aichi-ken (JP); Naoki Yamamuro, Nagoya-shi Aichi-ken (JP)

(21) Appl. No.: 16/241,225

(22) Filed: Jan. 7, 2019

(30) Foreign Application Priority Data
Jan. 9, 2018 (JP) 2018-001413

(51) Int. Cl. G10L 13/04; G10L 15/26; B60Q 9/00; B60W 50/14

(52) U.S. Cl. CPC G10L 13/043; B60W 50/14; B60Q 9/00; G10L 15/265

(57) ABSTRACT

A voice output device is provided that includes an acquisition unit that acquires a vehicle state and an output unit that, in a case in which the vehicle state acquired by the acquisition unit indicates an abnormality in the vehicle, outputs a sound associated with the vehicle state.

### CROSS-REFERENCE TO RELATED APPLICATION

This application claims priority under 35 USC 119 from Japanese Patent application No. 2018-001413 filed on Jan. 9, 2018, the disclosure of which is incorporated by reference herein in its entirety,

### BACKGROUND

### Technical Field

The present disclosure relates to a voice output device, a voice output method, and a program storage medium.

### Related Art

Conventionally, agent devices have been known each of which, by making an agent perform a disobedient action, causes a user to feel a sense of intimacy with the agent, thereby making an agent function a more suitable function. For example, see Japanese Patent Application Laid-Open (JP-A) No. 2007-241535. Each of the agent devices enables a dialogue between a user and an agent.

However, a technology described in JP-:A No. 2007-24 1535 does not take into consideration a case in which a dialogue device having a dialogue with a passenger in a vehicle is installed in the vehicle.

### SUMMARY

The present disclosure provides a voice output device, a voice output method, and a program storage medium that are capable of conveying a state of a vehicle to users appropriately in a case in which an abnormality occurred in the vehicle.

A voice output device according to a first aspect of the present disclosure includes an acquisition unit that acquires a vehicle state and an output unit that, in a case in which the vehicle state acquired by the acquisition unit indicates an abnormality in the vehicle, outputs a sound associated with the vehicle state.

The voice output device of the first aspect acquires a vehicle state. The voice output device outputs a sound associated with the vehicle state in a case in which the acquired vehicle state indicates an abnormality in the vehicle. This configuration enables a state of the vehicle to be conveyed to users appropriately in a case in which an abnormality occurred in the vehicle.

A voice output device according to a second aspect of the present disclosure further includes an utterance acquisition unit that acquires an utterance emitted by a user, in which the output unit outputs the sound associated with the vehicle state and the utterance emitted by the user. The user means a passenger who is on board a vehicle or a person different from the passenger.

The voice output device of the second aspect acquires an utterance emitted by a user and outputs a sound associated with a vehicle state and the utterance emitted by the user. Since this configuration causes the sound associated with an utterance from the outside and a vehicle state to the output, it is possible to convey a state of the vehicle appropriately in response to an utterance from a user.

A non-transitory storage medium according to, a third aspect of the present disclosure is a storage medium storing a program causing a computer to execute processing including acquiring a vehicle state and, in a case in which the acquired vehicle state indicates an abnormality in the vehicle, outputting a sound associated with the vehicle state.

A voice output method according to a fourth aspect of the present disclosure is a voice output method including acquiring a vehicle state and, in a ease in which the acquired vehicle state indicates an abnormality in the vehicle, outputting a sound associated with the vehicle state.

As described above, the present disclosure enables a state of a vehicle to be conveyed to users appropriately in a case in which an abnormality occurred in the vehicle.

### BRIEF DESCRIPTION OF THE DRAWINGS

Exemplary embodiments of the present disclosure will be described in detail based in the following figures, wherein:

FIG. 1 is a schematic block diagram of a dialogue device according to an embodiment;

FIG. 2 is an explanatory diagram for a description of an outline of the embodiment;

FIG. 3 is an explanatory diagram for a description of an example of utterances according to vehicle states;

FIG. 4 is an explanatory diagram for a description of another outline of the embodiment;

FIG. 5 is a diagram illustrating a configuration example of a computer in the dialogue device;

FIG. 6 is a flowchart illustrating an example of processing performed by the dialogue device according to the embodiment; and

FIG. 7 is a flowchart illustrating another example of the processing performed by the dialogue device according to the embodiment.

### DETAILED DESCRIPTION

### First Embodiment

Hereinafter, a dialogue device 10 according to a first embodiment will be described referring to the drawings.

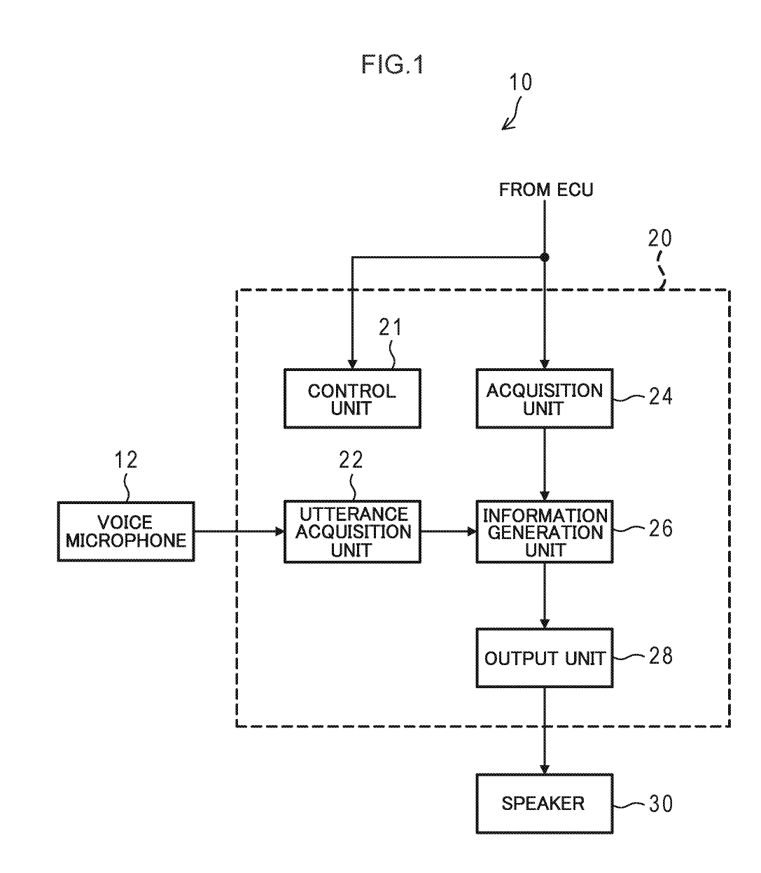

FIG. 1 is a block diagram illustrating an example of a configuration of the dialogue device 10 according to the first embodiment. As illustrated in FIG. 1, the dialogue device 10 includes a voice microphone 12, a computer 20, and a speaker 30. The dialogue device 10 is an example of a voice output device of the present disclosure.

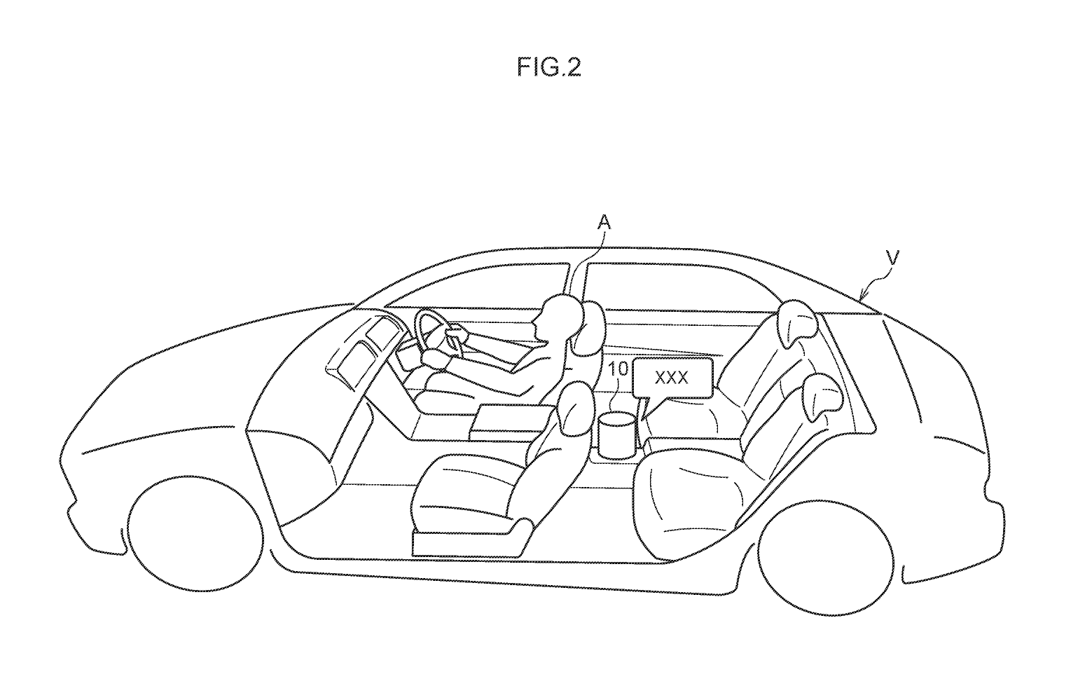

As illustrated in FIG. 2, the dialogue device 10 is installed in a vehicle V. The dialogue device 10 performs a dialogue with a passenger A in the vehicle. For example, in response to an utterance “What is the weather today?” emitted by the passenger A, the dialogue device 10 outputs an utterance “The weather today is H.” from the speaker 30. For example, in response to an utterance “Play music.” emitted by the passenger A, the dialogue device 10 plays music from the speaker 30.

The voice microphone 12 detects an utterance from a passenger who is present in a vicinity of the dialogue device 10. The voice microphone 12 outputs the detected utterance from the passenger to the computer 20, which will be described later.

The computer 20 is configured including a central processing unit (CPU), a read only memory (ROM) storing a program and the like for achieving respective processing routines, a random access memory (RAM) storing data temporarily a memory serving as a storage unit, a network interface, and the like. The computer 20 functionally includes a control unit 21, an utterance acquisition unit 22, an acquisition unit 24, an information generation unit 26, and an output unit 28.

In a case in which a position of the dialogue device 10 is inside the vehicle V, the control unit 21 sets the dialogue device 10 in a mode (hereinafter, referred to as a driving mode) in which a vehicle state representing a state of the vehicle V can be acquired. For example, the control unit 21 in the dialogue device 10 acquires a vehicle state through communication with an electronic control unit (ECU) (illustration omitted) that is mounted in the vehicle V. Ina case in which the control unit 21 in the dialogue device 10 has detected that the dialogue device 10 is inside the vehicle V, the control unit 21 sets the dialogue device 10 in the driving mode.

The utterance acquisition unit 22 successively acquires utterances detected by the voice microphone 12.

The acquisition unit 24 performs exchange of information with the ECU, which is mounted in the vehicle V. Specifically, the acquisition unit 24 successively acquires vehicle states each of which represents a state of the vehicle V. The acquisition unit 24 outputs the acquired vehicle states to the information generation unit 26. In a vehicle state, information indicating whether or not an abnormality has occurred in the vehicle V is included.

In a case in which, based on a vehicle state acquired by the acquisition unit 24, the information generation unit 26 determines that the vehicle state indicates that an abnormality has occurred in the vehicle V, the information generation unit 26 generates an utterance according to the abnormality, which has occurred in the vehicle V.

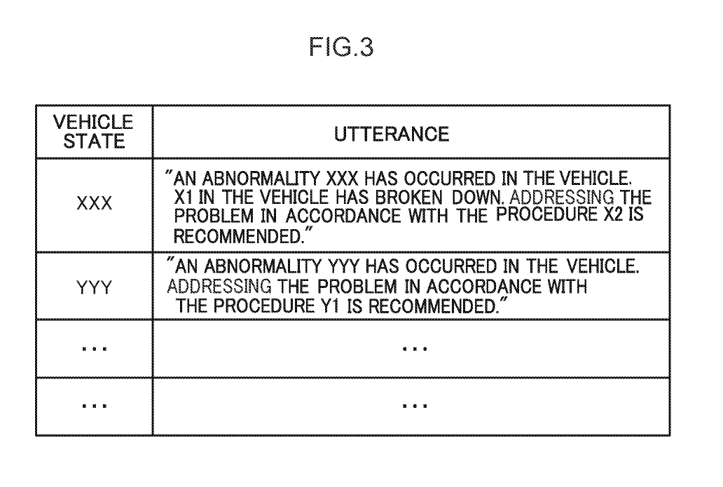

For example, in a case in which an abnormality has occurred in the vehicle V, a signal representing a vehicle state that indicates that the abnormality has occurred in the vehicle V is output from the ECU. The information generation unit 26 generates an utterance according to a signal representing a vehicle state. For example, in a case in which the information generation unit 26 has acquired a vehicle state. “XXX” indicating an occurrence of an abnormality in the vehicle V, the information generation unit 26 generates an utterance like “An abnormality XXX has occurred in the vehicle. X1 in the vehicle has broken down. Addressing the problem in accordance with the procedure X2 is recommended”. Contents of such utterances are set in advance according to vehicle states. For example, in a case in which, as illustrated in FIG. 3, a table that associates vehicle states with utterances is prepared in advance, the information generation unit 26 selects an utterance according to a vehicle state. Contents of “XXX”, “X1”, “X2”, “YYY”, and “Y1” in the utterances are set in advance associated with vehicle states.

The output unit 28 outputs an utterance generated by the information generation unit 26 to the speaker 30.

The speaker 30 outputs by voice the utterance output by the output unit 28.

For example, in a case in which, after an utterance has been output from the speaker 30, the passenger A in the vehicle has emitted an utterance like “Is the state of Z1 all right?”, the voice microphone 12 detects the utterance and outputs the detected utterance to the computer 20.

The utterance acquisition unit 22 in the computer 20 acquires the utterance detected by the voice microphone 12.

Based on a vehicle state acquired by the acquisition unit 24 and an utterance acquired by the utterance acquisition unit 22, the information generation unit 26 generates an utterance associated with the utterance emitted by the passenger A and an abnormality having occurred in the vehicle V. For example, the information generation unit 26 infers a dialogue action with regard to an utterance acquired by the utterance acquisition unit 22, determines that the utterance is an inquiry about “Z1”, and generates an utterance like “Z1 is in a state of Z2,” as an answer to the inquiry and, in conjunction therewith, generates an utterance like “Performing Z3 is recommended.” according to the vehicle state acquired by the acquisition unit 24.

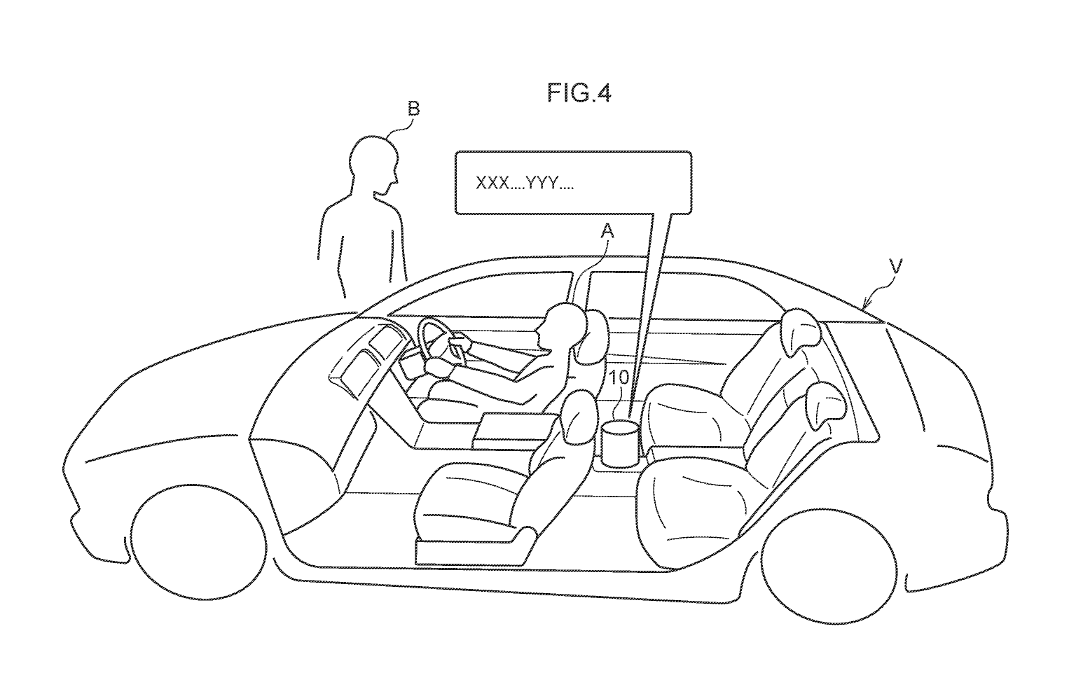

Although, in FIG. 2, an example in which the dialogue device 10 outputs an utterance to the passenger A is illustrated, a case in which, as illustrated in FIG. 4, the dialogue device 10 outputs an utterance to a person B who is different from the passenger A is also conceivable.

As illustrated in FIG. 4, an utterance being output to the person B, who is different from the passenger A, enables a state of the vehicle to be conveyed to the person B even in a case in which an abnormality occurred in the vehicle and caused the passenger A to be upset. Even in a case in which the passenger A has not fully grasped a vehicle state, the state of the vehicle may also be conveyed appropriately to the person B.

In a case in which the passenger A is a foreigner, that is, not Japanese, the passenger A, for example, sets the dialogue device 10 in such a way that an utterance from the dialogue device 10 is output in Japanese by operating an operation unit (illustration omitted) of the dialogue device 10. This setting enables a state of the vehicle to be conveyed appropriately to the person B even in a case in which the passenger A is a foreigner, not Japanese.

Further, even in a case in which the passenger A is in a state of losing consciousness and the like, a state of the vehicle may be conveyed appropriately to the person B.

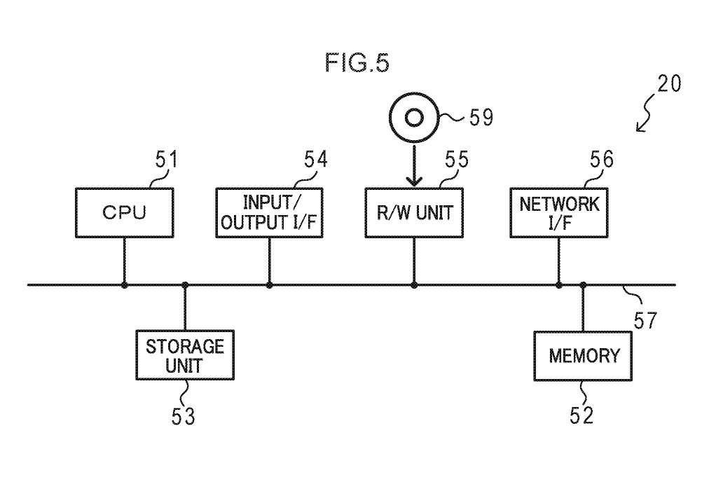

The computer 20 in the dialogue device 10 may, for example, be achieved by a configuration as illustrated in FIG. 5. The computer 20 includes a CPU 51, a memory 52 as a temporary storage area, and a nonvolatile storage unit 53. The computer 20 also includes an input/output interface (I/F) 54 to which an input/output device and the like (illustration omitted) are connected and a read/write (R/W) unit 55 that controls reading and writing of data from and to a recording medium 59. The computer 20 still also includes a network I/F 56 that is connected to a network, such as the Internet. The CPU 51, the memory 52, the storage unit 53, the input/output I/F 54, the R/W unit 55, and the network I/F 56 are interconnected via a bus 57.

The storage unit 53 may be achieved by a hard disk drive (HDD), a solid state drive (SSD), a flash memory, or the like. In the storage unit 53 serving as a storage medium, a program for making the computer 20 function is stored. The CPU 51 reads the program from the storage unit 53, expands the program in the memory 52, and successively executes processes that the program includes. This configuration causes the CPU 51 in the computer 20 to function as each of the control unit 21, the utterance acquisition unit 22, the acquisition unit 24, the information generation unit 26, and the output unit 28. The acquisition unit 24 and the output unit 28 are respectively examples of the acquisition unit and the output unit of the present disclosure.

Next, operation of the embodiment will be described.

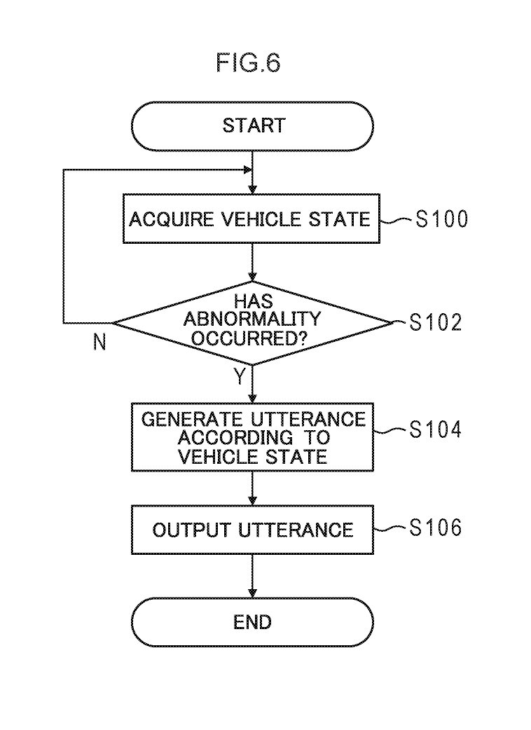

After the dialogue device 10 is brought in into a vehicle, the control unit 21 in the dialogue device 10 detects that the dialogue device 10 is inside the vehicle. The control unit 21 in the dialogue device 10 sets the dialogue device 10 in the driving mode. When vehicle states are being output from the ECU of the vehicle, the dialogue device 10 executes an utterance generation processing routine illustrated in FIG. 6.

In step S100, the acquisition unit 24 acquires a vehicle state of the vehicle V.

In step S102, the information generation unit 26 determines whether or not an abnormality has occurred in the vehicle V, based on the vehicle state acquired in the above step S100. In a case in which an abnormality has occurred in the vehicle V, the process proceeds to step S104. In a case in which no abnormality has occurred in the vehicle V, the process returns to step S100.

In step S104, the information generation unit 26 generates an utterance according to the abnormality, which has occurred in the vehicle V, based on the vehicle state acquired in the above step S100. For example, in a case in which the vehicle state is “XXX”, the information generation unit 26 generates an utterance “An abnormality “XXX” has occurred in the vehicle. X1 in the vehicle has broken down. Addressing the problem in accordance with the procedure X2 is recommended,” in accordance with the table illustrated in FIG. 3.

In step S106, the output unit 28 outputs the utterance generated in the above step S104 to the speaker 30.

The speaker 30 outputs by voice the utterance output by the computer 20.

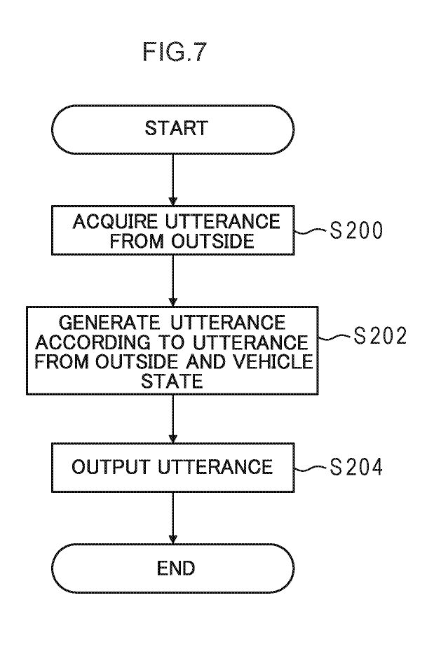

Next, a passenger A or a person B who is different from the passenger A talks to the dialogue device 10. When the voice microphone 12 of the dialogue device 10 detects an utterance from the outside, the dialogue device 10 executes an utterance generation processing routine illustrated in FIG. 7.

In step S200, the utterance acquisition unit 22 acquires the utterance from the outside, which was detected by the voice microphone 12.

In step S202, based on the vehicle state and the utterance acquired in the above step S200, the information generation unit 26 generates an utterance according to the utterance acquired in the above step S200 and the abnormality having occurred in the vehicle V.

In step S204, the output unit 28 outputs the utterance generated in the above step S202 to the speaker 30.

The speaker 30 outputs by voice the utterance output by the computer 20.

As described thus far, a dialogue device according to the embodiment acquires a vehicle state representing a state of a vehicle and, in a case in which the vehicle state indicates an abnormality in the vehicle, outputs an utterance according to the vehicle state. This configuration enables a state of the vehicle to be conveyed to users appropriately in a case which an abnormality occurred in the vehicle.

The dialogue device according to the embodiment acquires an utterance emitted by a user and outputs an utterance according to a vehicle state and the utterance from the user. Since this configuration causes an utterance according to an utterance from the outside and a vehicle state to be output, it is possible to convey a state of the vehicle appropriately in response to an utterance from a user.

Although the processing performed by the dialogue device in the embodiment described above was described as software processing performed by executing a program, the processing may be configured to be performed by hardware. Alternatively, the processing may be configured to be performed by a combination of both software and hardware. The program to be stored in the ROM may be distributed stored in various types of storage media.

The present disclosure is not limited to the above embodiment, and it is needless to say that various modifications other than those described above may be made and implemented without departing from the subject matter of the present disclosure.

For example, a dialogue device in the embodiment described above may be achieved by a mobile terminal and the like. In this case, an utterance according to a vehicle state is output from a mobile terminal, based on a dialogue function of the mobile terminal.

What is claimed:

1. A voice output device comprising:
a memory; and
a processor coupled to the memory and configured to:
acquire a vehicle state; and
output a sound associated with the vehicle state, in a case in which the vehicle state indicates an abnormality in the vehicle.

2. The voice output device according to claim 1,
wherein the processor is further configured to:
acquire an utterance emitted by a user, and
output the sound associated with the vehicle state and the utterance emitted by the user.

3. A non-transitory storage medium storing a program causing a computer to execute processing comprising
acquiring a vehicle state; and
in a case in which the acquired vehicle state indicates an abnormality in the vehicle, outputting a sound associated with the vehicle state.

4. A voice output method comprising:
acquiring a vehicle state; and
in a case in which the acquired vehicle state indicates an abnormality in the vehicle, outputting a sound associated with the vehicle state.
